(19) United States
(12) Patent Application Publication
(10) Pub. No.: US 2008/0253342 A1
(43) Pub. Date: Oct. 16, 2008

(54) Signaling in convergence sublayer in WiMAX

(75) Inventors: Tricci So, San Diego, CA (US); Nanjian Qian, San Diego, CA (US); Cancan Huang, Poway, CA (US)

Correspondence Address: FISH & RICHARDSON, PC, P.O. BOX 1022, MINNEAPOLIS, MN, 55440-1022, US

(73) Assignee: ZTE (USA) Inc.

(21) Appl. No.: 12/101,085

(22) Filed: Apr. 10, 2008

Related U.S. Application Data
(60) Provisional application No. 60/911,035, filed on Apr. 10, 2007.
(60) Provisional application No. 60/916,795, filed on May 8, 2007.

(51) Int. Cl. H04Q 7/24

(52) U.S. Cl. 370/338

(57) ABSTRACT

Examples and implementations of techniques for providing an efficient and flexible convergence sublayer service enablement strategy in establishing the initial service flows and pre-provision service flows during the initial Mobile Subscriber (MS) Terminal network entry time (i.e. attachment to the WiMAX access network).

### PRIORITY CLAIM AND RELATED APPLICATIONS

This application claims benefits of U.S. Provisional Application No. 60/911,035 entitled “Signaling in convergence sublayer in WiMax” and filed on Apr. 10, 2007 and U.S. Provisional Application No. 60/916,795 entitled “Signaling in convergence sublayer in WiMax” and filed on May 8, 2007, which are incorporated by reference as part of the specification of this application.

### BACKGROUND

This application relates to wireless communication systems and techniques for wireless communications.

Wireless communication systems provide voice or data services to subscriber stations or mobile stations (e.g., wireless or mobile stations) situated within a geographic region by dividing the region into a number of cells. Each cell may be further divided into two or more sectors. Each cell contains system communication equipment such as a base station that transmits communication signals to fixed or mobile subscriber stations on the forward link and receives communication signals from the subscriber stations on the reverse link. One example of wireless communication systems based on the above cellular design is wireless networks based on WiMAX (wireless interoperability for microwave access) technology based on IEEE 802.16 standards (e.g., IEEE 802.16e).

Current IEEE 802.16 Standard and WiMAX Network Working Group Release 1.0 Specification support the concepts of Service Flow (SF) which composes of Initial Service Flows, Pre-provisioned Service Flows and Dynamic Service Flow to support different transport layer services over the IEEE 802.16/WiMAX defined convergence sublayer. A service flow (SF) is a unidirectional flow of data that has been assigned with a specific set of QoS parameters. A SF is used in WiMAX access network to carry both the control signaling and user traffic. All the service flows are managed by WiMAX access network. Pre-provisioned service flows is a specific type of service flows that is pre-configured for the subscriber and will be activated during the network entry time once the MS is successfully authenticated. The Initial Service Flow (ISF) is a special kind of a Pre-Provisioned “unicast” Service Flow which is designed for providing the basic connectivity between the subscriber terminal and the external network via the WiMAX access network. Among the set of pre-provisioned service flows, the very first pair of service flows (i.e. one for uplink and one for downlink) that are established by the Service Flow Agent (SFA) in the WiMAX access network are called the ISFs. In general, the ISF is used to transfer delay tolerant control traffic such as standards-based IP configuration management and IP client application signaling (e.g. DHCP DISCOVERY, FA Advertisement, Mobile IP Registration, Router Advertisement, SIP signaling etc.) to support the IP-based Convergence Sublayer (i.e. IP-CS) as well as configuration management signaling required for Ethernet-based Convergence Sublayer (i.e. Eth-CS). The Convergence Sublayer (CS) is a WiMAX specific protocol sublayer which converges different types of transport layer protocol SDUs to a single Service Access Point (SAP) interface specified by IEEE 802.16 Medium Access Control (MAC) layer. This capability of CS allows the IEEE 802.16 MAC to be compatible with different transport layer protocols.

### SUMMARY

This application includes examples and implementations of an efficient and flexible convergence sublayer service enablement strategy in establishing the initial service flows and pre-provision service flows during the initial Mobile Subscriber (MS) Terminal network entry time (i.e. attachment to the WiMAX access network).

In one aspect, a method for providing communications in a WiMAX network includes providing a WiMAX access network to provide wireless communications to mobile subscriber (MS) stations and providing a convergence sublayer service message in establishing initial service and pre-provision service flows for establishing an initial communication between a MS station and the WiMAX access network. The convergence sublayer service message includes a first convergence sublayer Type-Length-Value (TLV) message and a second convergence sublayer TLV message. This method also includes using both the first convergence sublayer TLV message and the second convergence sublayer TLV message to establish communications between the MS station and the WiMAX access network. When the first convergence sublayer TLV message fails to initialize, the second convergence sublayer TLV message is used to support the communications between the MS station and the WiMAX access network.

In another aspect, a WiMAX communication system is provided to include a WiMAX radio access service network (ASN) in radio wireless communications with one or more mobile subscriber (MS) stations to provide communication services to the one or more MS stations; and means for providing a convergence sublayer service message in establishing initial service and pre-provision service flows for establishing an initial communication with a MS station. The convergence sublayer service message includes a first convergence sublayer Type-Length-Value (TLV) message and a second convergence sublayer TLV message. This system also includes means for operating both the first convergence sublayer TLV message and the second convergence sublayer TLV message to establish communications with the MS station and to, when the first convergence sublayer TLV message fails to initialize, use the second convergence sublayer TLV message to support the communications with the MS station without re-authenticating the MS station.

These and other aspects and various implementations are described in greater detail in the drawing, the description and the claims.

### BRIEF DESCRIPTION OF DRAWINGS

FIG. 1 shows an example of a wireless WiMAX network design that can implement the signaling in present convergence sublayer described in this application.

FIGS. 2A and 2B shows two examples of the radio access service network (ASN) Reference Model containing a single ASN-Gateway (GW) and multiple ASN-GWs.

FIG. 3 illustrates an example of communications in a WiMax system that implements the present convergence sublayer (CS) signaling.

FIG. 4 shows an example for the service flow creation in the system in FIG. 1.

### DETAILED DESCRIPTION

This application describes, among others, an efficient and flexible convergence sublayer service enablement strategy in establishing the initial service flows and pre-provision service flows during the initial Mobile Subscriber (MS) Terminal network entry time (i.e. attachment to the WiMAX access network).

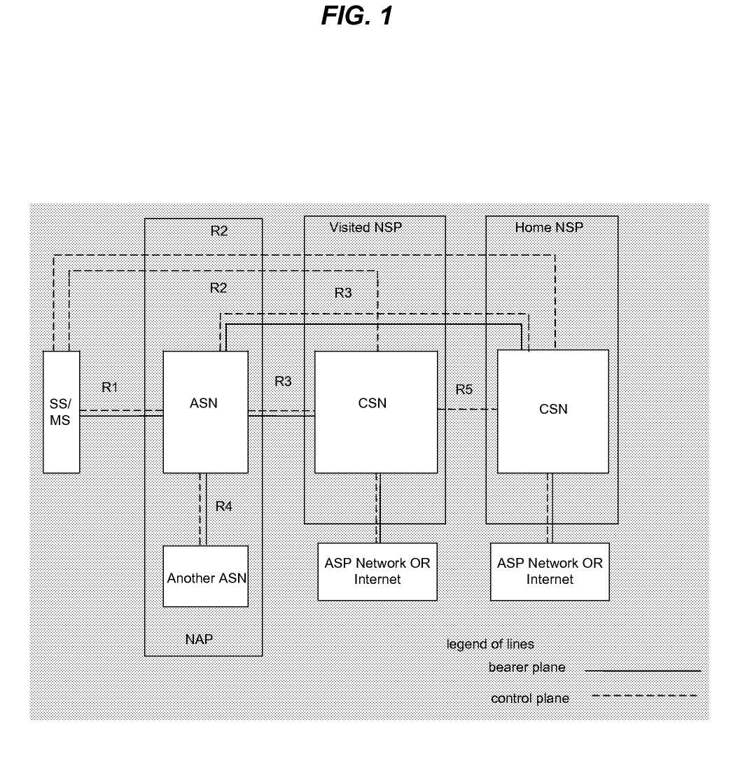

FIG. 1 shows an example of a wireless WiMAX network design that can implement the signaling in present convergence sublayer described in this application. The system includes a network of base stations (BSs) or base transceiver stations (BSTs) that are spatially distributed in a service area to form an access radio network (ASN) for wireless subscriber stations (SSs) or Mobile Stations (MSs). A SS or MS may be any communication device capable of wirelessly communicating with base stations and may be implemented as a mobile SS or a fixed SS which may be relocated within the system. Examples of a stationary wireless device may include desktop computers and computer servers. Examples of a mobile wireless device may include mobile wireless phones, Personal Digital Assistants (PDAs), and mobile computers. A base station in the system is a radio transceiver that is conceptually at a center of a cell and wirelessly communicates with a MS in the cell via downlink radio signals. Each BS may be designed to have directional antennas and to produce two or more directional beams to further divide each cell into different sections. Base station controllers (BSCs) are provided in the system to control the BSs. Each BSC is connected to a group of two or more two or more designated BSs and controls the connected BSs. One or more ASN Gateway (GW) units are provided in each ASN to control the BSCs and the corresponding BSs. The wireless WiMAX network can include at least one ASN and may include two or more ASNs. Each ASN is connected to a carrier IP network which carries data. The wireless WiMAX network in FIG. 1A also includes a Connectivity Serving Network (CSN) for WiMAX communications. Optionally, the wireless WiMAX network in FIG. 1A can be structured to support multihop relay (MR) base stations that expand the radio coverage of the radio access network. The ASN can include one or more ASN-MR servers and the CSN can include one or more CSN-MR servers.

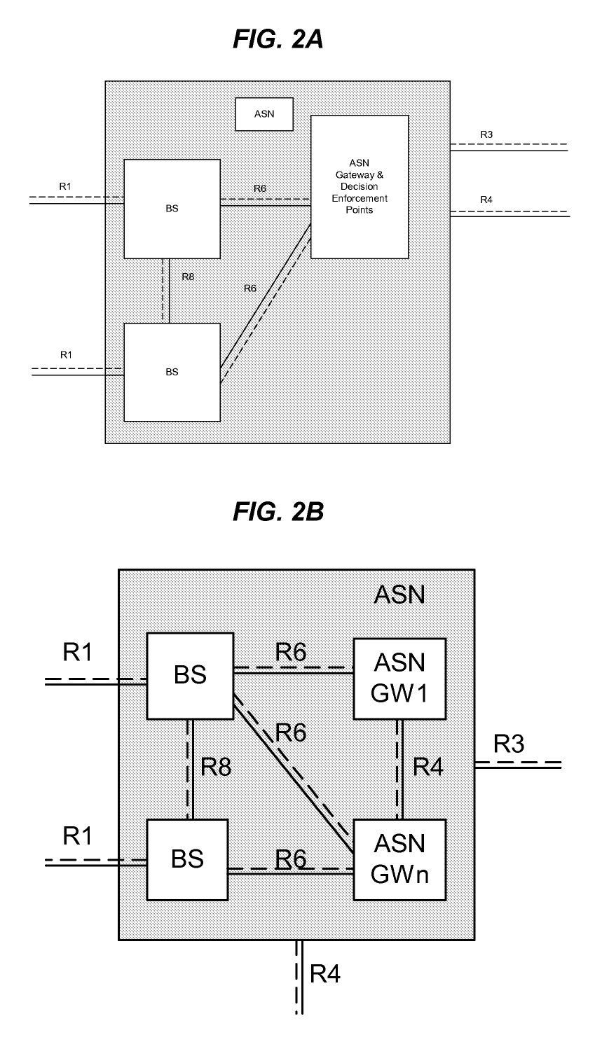

FIG. 1 is in essence a logical representation of the WiMAX network architecture based on Network Reference Model (NRM). The NRM identifies functional entities and reference points over which interoperability is achieved between functional entities. FIG. 1 depicts normative reference points R1-R5. FIGS. 2A and 2B shows two examples of the access radio network (ASN) Reference Model containing a single ASN-Gateway (GW) and multiple ASN-GWs, respectively, for the ASN in FIG. 1.

Each of the entities, MS, ASN and CSN represent a grouping of functional entities. Each of these functions may be realized in a single physical functional entity or may be distributed over multiple physical functional entities. The grouping and distribution of functions into physical devices within the ASN is an implementation choice. The intent of the NRM is to allow multiple implementation options for a given functional entity, and yet achieve interoperability among different realizations of functional entities. Interoperability is based on the definition of communication protocols and data plane treatment between functional entities to achieve an overall end-to-end function, for example, security or mobility management. A reference point (RP) is a conceptual link that connects two groups of functions that reside in different functional entities of an ASN, CSN, or MS and thus RP is not necessarily a physical interface. A reference point becomes a physical interface when the functional entities on either side of the RP are contained in different physical MSs. The functional entities on either side of RP represent a collection of control and Bearer Plane end-points. In this setting, interoperability will be verified based only on protocols exposed across an RP, which would depend on the end-to-end function or capability realized (based on the usage scenarios supported by the overall network).

Reference Point R1 includes the protocols and procedures between MS and ASN as per the air interface (PHY and MAC) specifications (IEEE P802.16e-2005, IEEE P802.16-2004 and IEEE 802.16g). Reference point R1 may include additional protocols related to the management plane. Reference Point R2 includes protocols and procedures between the MS and CSN associated with Authentication, Services Authorization and IP Host Configuration management. The authentication part of reference point R2 runs between the MS and the CSN operated by the home NSP, however the ASN and CSN operated by the visited NSP may partially process the aforementioned procedures and mechanisms. Reference Point R2 might support IP Host Configuration Management running between the MS and the CSN (operated by either the home NSP or the visited NSP). Reference Point R3 includes the set of Control Plane protocols between the ASN and the CSN to support AAA, policy enforcement and mobility management capabilities. It also encompasses the Bearer Plane methods (e.g., tunneling) to transfer user data between the ASN and the CSN. Reference Point R4 includes a set of Control and Bearer Plane protocols originating/terminating in various functional entities of an ASN that coordinate MS mobility between ASNs and ASN-GWs. R4 is the only interoperable RP between similar or heterogeneous ASNs. Reference Point R5 includes the set of Control Plane and Bearer Plane protocols for internetworking between the CSN operated by the home NSP and that operated by a visited NSP. Reference point R6 includes the set of control and Bearer Plane protocols for communication between the BS and the ASN-GW. The Bearer Plane consists of intra-ASN datapath between the BS and ASN gateway. The Control Plane includes protocols for datapath establishment, modification, and release control in accordance with the MS mobility events. However, when protocols and primitives over R8 are defined, MAC states will not be exchanged over R6.

WiMAX Networking Group (NWG) has defined a special SF resource combined indicator carried in the data structure—Combined Resource Required TLV (Type/Length/Value). This TLV is used as a group indicator to determine whether the subscriber service profile of the mobile subscriber (MS) requires the WiMAX access network (ASN) to set up every pre-provisioned service flows successfully prior to activate the convergence sublayer service for the MS. According to the IEEE 802.16e-2005, multiple CS Types can be supported simultaneously (e.g. IPv4 CS, Ethernet CS, IPv6 CS, etc.) for the given MS. Hence, each activated CS type for the given MS requires separate ISFs to be established. However, in stage-3 specification, only a single Combined Resource Required flag is defined. With this approach, if the ISFs of one CS types fail to be initialized for the MS, and if the Combined Resource Required flag is set, other CS type(s) for the given MS will also be penalized even though they may be operational for the MS.

In NWG Network Entry Procedure, ISF and pre-provisioned service flow setup phase will be started only after MS has been successfully authenticated by the WiMAX access network. In the original WiMAX recommendation, if any of the ISF is not established by the local ASN , the MS is denied of the service by the local ASN. In the transient network resource congestion situation, it is possible that the ISF may not be successfully established the very first trial. Also, the MS usually needs a long time to get through the initial access authentication phase. In order to enhance the user experience by allowing the MS fast attachment without waiting for the complete re-authentication, the techniques described in this application can be used to allow the access network to retry for the SF re-establishment rather than forcing the MS re-entry via re-authentication process.

In one implementation, a compound TLV named Combined Resource Indicator TLV is provided to include two sub-TLVs: (1) CS Type and (2) Combined Resources Required. When one CS type fails to be initialized, the other CS type(s) can continue to support the MS operation in the WiMAX network. This scheme allows for a secondary sub-TLV to be used for re-entry of the SF for the MS without re-authentication and thus can increase the user service availability for our system.

If the “Combined Resource Required” flag for “all” CS Types (i.e. for ‘all’ pre-provisioned service flows of ‘all’ CS types) is “set” at the MS level, the per-MS level “Combined Resource Required” flag should over-rule all the per-CS level “Combined Resource Required” flags regardless of their settings.

Combined Resource Indicator

| Type | 204 | |
|---|---|---|
| Length in | 3 | |
| octets | | |
| Value | Compound | |
| Description | This TLV indicates if all the pre-provisioned service flows | |
| | for the corresponding CS type are required to be established | |
| | successfully for a MS. This TLV could have one or more | |
| | instances dependent on the number of CS Types that are | |
| | allowed for the MS. | |
| Elements | TLV Name | M/O |
| (Sub-TLVs) | CS Type | M |
| | Combined Resources Required | M |
| Parent TLV | SF Info | |

Therefore, the implementation shown above provides a new compound TLV named Combined Resource Indicator TLV. This new TLV includes two sub-TLVs, CS Type and Combined Resources Required. When the Combined Resources Required flag is set, and the CS Type is set to null to indicate that the given Combined Resources Required indicator is per-MS level and not per-CS level. Otherwise, the Combined Resource Required flag is per-CS level. As a result, when one CS type fails to be initialized, the other CS type(s) can continue to support the MS operation in the WiMAX network. By doing this, it can increase the user service availability for our system.

This implementation also provides a network wide retry flag and timer per CS type to retry the ISF re-establishment with the WiMAX access network.

In addition, this implementation provides a Convergence Sublayer Activation Strategy Algorithm to control the activation operations. One example for this algorithm is provided below and includes ISF establishment per CS type and pre-provisioned SF setup per CS Type.

Algorithm: ISF Establishment per CS Type

```
MS-In-Service = False;
For (i = 1, i <= max-num-of-cs-types, i++)
Do
      /* First time, try to set up the ISFs for “all” CS types */
      Setup ISF(CS_Type[i]);
EndFor
For (i = 1, i <= max-num-of-cs-types, i++)
Do
      For (j=1, j <= CS_Type[i].Max-Retry, j++)
      Do
            /* ISF set retry is on a per CS type basis */
      If (ISF(CS_Type[i].In-Service) == False) Then
      Wait (CS_Type[i].Retry-Timer);
      Setup ISF(CS_Type[i]);
            Else
                  MS-In-Service = True;
                  ExitFor(j);
      EndIf
      EndFor{j}
EndFor{i}
/* NOTE: */
/* The algorithm above can be modified to allow the retry of the ISF
establishment for each CS type done in parallel */
/* If no CS type is activated for the MS, reject the MS attachment to the
WiMAX network */
If (MS-In-Service == False) Then
      Reset MS( );
Else
      Start Pre-provisioned_SF_Setup_per_CS_Type( )
EndIf
```

Algorithm Pre-provisioned SF Setup per CS Type

```
MS-In-Service = False; /* Initialize the local flag to flase */
For (i = 1, i <= max-num-of-cs-types, i++)
Do
      MS[i].CS-In-Service = True;
EndFor{i}
For (i = 1, i <= max-num-of-cs-types, i++)
Do
For (j=1, j <= CS_Type[i, j].Num_of_SF, j++)
Do
      If (ISF(CS_Type[i].In-Service) Then
Setup Pre-Provisioned_SF(CS_Type[i, j]);
If (Pre-Provisioned_SF(CS_Type[i, j].Setup.Success == False) then
                  If
(Combined_Resource_Required(CS_Type[i]) == True) Then
                        MS[i].CS-In-Service = False
                        ExitFor{j};
                  EndIf
            Endif
      EndIf
EndDo{j}
EndFor{i}
For (i = 1, i <= max-num-of-cs-types, i++)
Do
      If (MS[i].CS-In-Service == True) Then
            MS-In-Service = True;
            ExitFor{i};
      EndIf
EndDo{i}
If (MS-In-Service == False) Then
      Reset MS( );
EndIf
```

The service flow management aspect includes QoS-related messages and such messages are used to create, modify and delete service flows over the air, NWG stage-2 specification (section 7.6.3) defines following: Pre-provisional service flow creation and deletion; Initial Service Flow creation and deletion; and Service Flow management to support MS mobility. Dynamic service creation procedures can also be implemented.

Pre-provisioned service flows are defined as service flows which are activated at network entry after successful MS access authentication. If any of the pre-provisioned service flows other than the initial service flow of the corresponding CS type is failed to be activated by the local ASN, and if the “Combined Resources Required” flag for the corresponding CS type for the associated MS is set, the MS is denied of the service by the local ASN for the corresponding CS type.

The Initial Service Flow is a special kind of a Pre-Provisioned Service Flow as described at the previous section. Among the set of pre-provisioned unicast service flows, the very first pair of service flows (i.e. for uplink and downlink) that are initiated by the SFA are called the Initial Service Flows (ISF). For each CS type that is required the MS, a separate pair of ISFs is required.

The ISF is used by the MS and the ASN to transfer delay to tolerant control traffic such as standards-based IP configuration management and IP client application signaling (e.g. DHCP DISCOVERY, FA Advertisement, Mobile IP Registration, Router Advertisement, SIP signaling etc.) in case of IP-CS as well as configuration management signaling required for Ethernet in case of Eth-CS.

If any of the initial service flow of a given CS type for the associate MS is failed to be activated by the local ASN, the MS shall be denied of the service for the given CS type. If none of the CS types can be activated successfully for the MS, the MS shall be denied of the service by the local ASN. Otherwise, if at least one of the CS types of the MS is operational, the ASN shall continue the support the MS operation at the local ASN.

The number of retries for the local ASN to attempt to establish the ISFs for the given CS type is local network policy decision and is outside the scope of this specification.

Referring back to FIG. 1, at the ASN, the SFA is responsible for assigned SFID to the service flow. As the pre-provisioning service flow information including the Packet Data Flow ID (PDFID) is downloaded to the ASN after the successful MS access authentication, the SFA is responsible to map one or more PDFIDs to a set of unidirectional service flows dependent on the service flow policy configuration information. Note that the PDFID can represent a unidirectional flow. To allow an option of the special monitoring of the ISF which is created for different CS types, this specification recommends the first 20 PDFID(s) from the unicast group of PDFIDs to be assigned to the IS (i.e. SFID range from 1-20) in both the uplink and downlink directions for each MS—i.e. the service flow pair for the given ISF is be assigned with a PDFID in the uplink, downlink or both directions.

By default, the ISF is assigned with the following set of policies; however, the default local policies can be modified dependent on the MS's subscription profile that is downloaded from the H-AAA or V-AAA after the successful MS access authentication as well as dependent on the local BS's policy. Examples of such policies include Best effort service class, Wildcard classifier, Transport both IP/Ethernet control and user traffic, Per service flow level of the granularity, HARQ disabled and ARQ enabled, Paging preference is set to 1, Traffic indication is set to 1, and Power Saving Class is set to type 1. To ensure the deterministic connection status of the ISF that the WiMAX application can rely on to leverage the ISF as the IP/Ethernet based management connection, the ISF SHALL remain operational as long as the MS is attached to the ASN. However, if any of the ISFs fails to be supported by the local ASN, the MS SHALL be denied of the service by the local ASN. Similar to other service flows maintenance in the ASN, the SFA is responsible for maintaining the ISF.

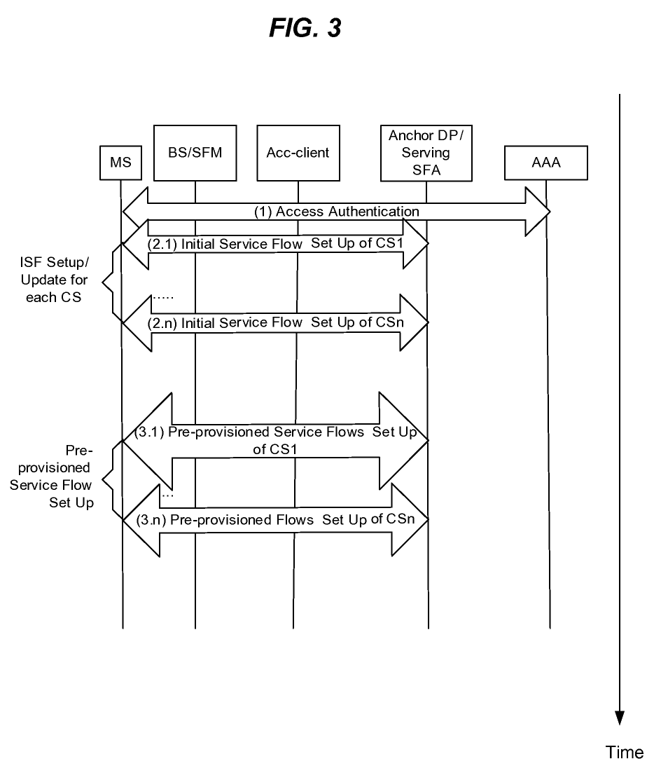

FIG. 3 illustrates the communications in a WiMax system that implements the above described CS signaling in establishing the service flow (SF) for the MS in connection with the BS (base station)/SFM (service flow module), Acc-client (Accounting client), Anchor DP (datapath)/Serving SFA (service flow authorization), and a server for AAA (authentication, authorization, and accounting) functions. The ISF of each CS can be seup parallel. If some CSs-related ISFs are not initiated, the MS can still be operational at the enabled CSs' service flows without being rejected by the network. The ISF establishment can be retried one or more multiple times based on the network policy. The pre-provisioned service flows can be set up parallel after all the CDs ISF are enabled successfully. Establishment of such pre-provisioned service flows can be retried one or more multiple times based on the network policy.

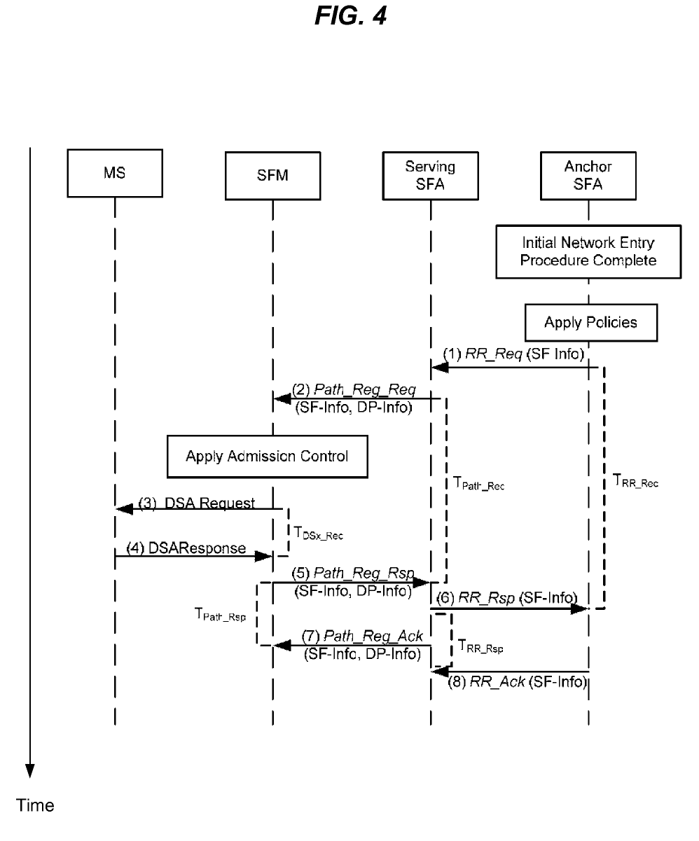

FIG. 4 shows an example of the Service Flow Creation.

Step 1

The QoS profile was received at the Anchor-SFA. RR_Req according to Table 4-61 is sent to the Serving-SFA where the QoS-parameters are set according to the received QoS-profile.

Step 2

Serving-SFA checks if a Data Path needs to be created. Depending on the result a Path_Reg_Req according to Table 4-67 (if a new DP is required) is sent to the SFM. The Path_Reg_Req include the received QoS-Info TLV received from the Anchor-SFA.

Step 3

The SFM verifies whether there are sufficient radio resources and it decides (based on the QoS-Info parameters and the available resources) whether the request should be accepted or not. In case of acceptance, a DSA-Request according to IEEE802.16e is sent to the MS.

Step 4

MS accepts or rejects the DSA-Request according to IEEE802.16e.

Step 5

Assuming acceptance by SFM in step 3 and acceptance by MS in step 4 (i.e. confirmation code of DSA-Response is OK/success) the SFM sends Path_Reg_Rsp messages according to Table 4-68/Table 4-70 to the Service SFA to confirm the reservation. In the case that reduced resources was granted by the SFM, the QoS parameter set of the granted resources SHALL be returned by the SFM in the response back to the Serving SFA.

Step 6

In case of successful response from the SFM, the Service SFA sends a RR_Rsp messages according to Table 4-63 with the QoS-Info parameters containing granted QoS values to the Anchor SFA to confirm the reservation. A response message not matching to a sent request (e.g. if SFID of a Path_Reg_Req do not match to a received Path_Reg_Ack) should be silently discarded.

Step 7

A Path_Req_Ack according to section 5.2.3.10 is sent to the SFM.

Step 8

In case of successful response from the Serving-SFA, the Anchor SFA sends back an RR_Ack, as shown in section 5.2.1.1, to the Serving-SFA. No further action is necessary by the Anchor-SFA except to keep the context until the MS performs network exit.

A response message not matching to a sent request (e.g. if SFID of a RR Req does not match to that of a RR Rsp) should be silently discarded.

The Anchor/Serving SFA takes care of SFID assignment on the Service Flows. An SFID SHALL uniquely represent a Service Flow within the MS. The first 20's SFIDs are reserved for the ISFs. Thus the Anchor/Serving SFA SHALL keep track of the SFIDs that have been already assigned to the MS. This is possible because the SFA is by definition the entity that takes care of service authorization for each particular MS. Thus the Anchor/Serving SFA simply assigns a new SFID by selecting a value, which is not yet in use in the MS with which the Service Flow is associated. This discipline guarantees that {MSID, SFID} pair is unique network wide. If the Anchor/Serving SFA imitates Service Flow creation, then the SFIDs are delivered to the SFM with DP-Registration Request sent from the Anchor/Serving SFA to the SFM. The SFM (in the Base Station) then uses the assigned SFIDs in the IEEE802.16e DSx message exchange with the MS. Upon a Service Flow release the Anchor/Serving SFA releases the associated SFID, which might be reused later for another, newly created, Service Flow.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Only a few implementations are disclosed. However, it is understood that variations and enhancements may be made.

What is claimed:

1. A method for providing communications in a WiMAX network, comprising:
providing a WiMAX access network to provide wireless communications to mobile subscriber (MS) stations;
providing a convergence sublayer service message in establishing initial service and pre-provision service flows for establishing an initial communication between a MS station and the WiMAX access network, wherein the convergence sublayer service message includes a first convergence sublayer Type-Length-Value (TLV) message and a second convergence sublayer TLV message;
using both the first convergence sublayer TLV message and the second convergence sublayer TLV message to establish communications between the MS station and the WiMAX access network, wherein, when the first convergence sublayer TLV message fails to initialize, the second convergence sublayer TLV message is used to support the communications between the MS station and the WiMAX access network.

2. The method as in claim 1, wherein:
the first convergence sublayer TLV message is a convergence sublayer (CS) type message and the second convergence sublayer TLV message is a Combined Resources Required message.

3. The method as in claim 1, comprising:
when the first convergence sublayer TLV message fails to initialize, operating the second convergence sublayer TLV message to support the communications between the MS station and the WiMAX access network without going through an authentication process for authenticating the MS station.

4. The method as in claim 1, comprising:
providing a network wide retry flag and a timer per convergence sublayer CS type to retry the Initial Service Flow (ISF) re-establishment with the WiMAX access network.

5. The method as in claim 1, comprising:
providing a convergence sublayer (CS) activation strategy algorithm to control activation of a convergence sublayer.

6. The method as in claim 5, wherein:
the convergence sublayer activation strategy algorithm includes an Initial Service Flow (ISF) establishment per CS type algorithm and a pre-provisioned service flow (SF) setup per CS Type algorithm.

7. A WiMAX communication system, comprising:
a WiMAX radio access service network (ASN) in radio wireless communications with one or more mobile subscriber (MS) stations to provide communication services to the one or more MS stations;
means for providing a convergence sublayer service message in establishing initial service and pre-provision service flows for establishing an initial communication with a MS station, wherein the convergence sublayer service message includes a first convergence sublayer Type-Length-Value (TLV) message and a second convergence sublayer TLV message; and
means for operating both the first convergence sublayer TLV message and the second convergence sublayer TLV message to establish communications with the MS station and to, when the first convergence sublayer TLV message fails to initialize, use the second convergence sublayer TLV message to support the communications with the MS station without re-authenticating the MS station.

8. The system as in claim 7, wherein:
the first convergence sublayer TLV message is a convergence sublayer (CS) type message and the second convergence sublayer TLV message is a Combined Resources Required message.

9. The system as in claim 7, comprising:
means for providing a network wide retry flag and a timer per convergence sublayer CS type to retry the Initial Service Flow (ISF) re-establishment for a MS station.

10. The system as in claim 7, comprising:
means for providing a convergence sublayer (CS) activation strategy algorithm to control activation of a convergence sublayer, wherein the convergence sublayer activation strategy algorithm includes an Initial Service Flow (ISF) establishment per CS type algorithm and a pre-provisioned service flow (SF) setup per CS Type algorithm.
